(19) United States
(12) Patent Application Publication
(10) Pub. No.: US 2005/0168483 A1
(43) Pub. Date: Aug. 4, 2005

(54) Device and method for processing video signal

(75) Inventor: Ken Hirata, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/034,110

(22) Filed: Jan. 13, 2005

(30) Foreign Application Priority Data
Jan. 30, 2004 (JP) 2004-024657

(51) Int. Cl. G09G 5/00

(52) U.S. Cl. 345/629

(57) ABSTRACT

A signal processing device and signal processing method. In this signal processing device, an on-screen generating section generates an on-screen signal and on-screen flags indicating the superimposition period of an on-screen signal in a video signal. A combining section combines an image based on a broadcast signal with an on-screen display, and outputs a composite image. This composite image is scaled in a scaling section according to a display region of a monitor. The on-screen flags are also scaled in a flag scaling section as in the case of the scaling processing with respect to the composite image. Consequently, the on-screen flags come to correspond to the display period of the on-screen display on the composite image. Use of the on-screen flags to make on-off control of the image quality adjustment eliminates the need for image quality adjustment, thereby preventing the on-screen display from having inferior visibility, and thus improving operability.

### CROSS-REFERENCE TO RELATED APPLICATIONS

This application is based upon and claims the benefit of priority from the prior Japanese Patent Application No. 2004-24657, filed on Jan. 30, 2004; the entire contents of which are incorporated herein by reference.

### BACKGROUND OF THE INVENTION

1. Field of the Invention

The present invention relates to a video signal processing device and video signal processing method that are suitable for a television receiver or the like performing an on-screen display on a flat panel of a liquid crystal display, plasma display, or the like.

2. Description of the Related Art

Display devices employ an on-screen display circuit (hereinafter referred to as an “OSD circuit”). Use of an OSD circuit allows an image based on an input video signal and an on-screen image based on an on-screen signal to be mutually superimposed for display on a display screen, by superimposing signals of characters, figures, menu screens, and/or the like on the video signal.

FIG. 1 is a block diagram of a television receiver having such an on-screen superimposing function. The television receiver in FIG. 1 is disclosed in Japanese Unexamined Patent Application Publication No. 2003-9094.

As shown in FIG. 1, the television receiver comprises a digital tuner 92 and a display device 93, and these are connected by a D connector, which is a connecter for a digital broadcast video signal. During the reception of a data broadcast, or by an input operation of a user, on-screen (graphic) signals of characters, figures, and/or the like are generated in a CPU 107 and data processing section 111. The on-screen signal is combined in a combination section 110 with a video signal passed through an MPEG (Moving Picture Experts Group) decoder section 106 and a conversion section 108.

The video signal obtained by combining the video signal and the on-screen signal (the resultant video signal is hereinafter refereed to as a “composite video signal”) is format-converted in a double-speed conversion section 115 of the display device 93, and scaled in a conversion section 116. Thereafter, the composite video signal undergoes an image quality adjustment in an adjusting section 117, and then supplied to a display 118. An image based on the composite video signal is thus displayed.

In recent years, as a display device, a flat panel of a liquid crystal panel, plasma display panel, or the like has come into actual use. In the flat panel, the image display is performed by supplying each pixel with a corresponding video signal. Therefore, when the number of pixels or the aspect ratio of an input video signal is different from those on the display screen, it is necessary to perform scaling processing for conforming the number of pixels and the aspect ratio of the input video signal to those of the flat panel by interpolation processing or the like with respect to the input video signal.

In this case, the on-screen image is also scaled as in the case of the scaling of an image based on an input video signal. That is, as shown in FIG. 1, prior to the scaling processing and image quality adjustment processing, combining processing with respect to images is to be performed.

However, the video signal to undergo an image quality adjustment has an on-screen signal superimposed thereon, and therefore, undesirably, the image quality of the on-screen display is also simultaneously adjusted by that image quality adjustment. As a result, an on-screen display, such as a menu display that is displayed by the user for an image quality adjustment, is also subjected to the image quality adjustment, which may impair operability. For example, when the brightness of the screen is adjusted to the lowest conditions by the image quality adjustment, the on-screen display itself, which is used for the purpose of the adjustment, becomes dark. This may make adjustment work difficult, or may make it impossible to finish the adjustment work.

One possible countermeasure to prevent such a problem is to perform scaling processing after combining processing and image quality adjustment processing. However, because the frequency band of the signal is widened and the calculation amount of scaling processing is increased by the image quality adjustment processing, this order of the processings is impractical for the flat panel.

When a cathode-ray tube (CRT) is used as a display device, processing equal to scaling can be achieved by controlling a deflection system. Namely, scaling processing can be done in the final stage after an image quality adjustment. In other words, an image quality adjustment, combination, and scaling can be performed in this order. Thus, when a CRT is used, superimposing the on-screen display on the video signal after having undergone an image quality adjustment prevents the on-screen display from having reduced visibility.

However, as described above, the television receiver using a flat panel involves the problems that it is necessary to scale a composite signal obtained by combining an input video signal and on-screen signals, and to perform an image quality adjustment immediately before making a display on the display screen, and that the on-screen image is also subjected to the image quality adjustment, resulting in deteriorated operability.

Japanese Unexamined Patent Application Publication No. 10-79899 discloses a device that allows an on-screen display to be clearly visible by adjusting an on-screen display signal even when the combination between a video signal and the on-screen display signal is performed in a pre-stage of the image quality adjustment. However, even the device set forth in the Japanese Unexamined Patent Application Publication No. 10-79899 does not allow an on-screen display completely freed from influence of image quality adjustment to be implemented, and suffers deterioration in its operability after the image quality adjustment.

### SUMMARY OF THE INVENTION

Accordingly, it is an object of the present invention to provide a video signal processing device and video signal processing method that generate an on-screen signal and simultaneously flag signals indicating the position of the on-screen signal, and that control the adjustment period of an image quality adjustment based on the flag signals, thereby allowing the on-screen display to become less susceptible to the image quality adjustment to improve the operability.

According to the present invention, a video signal processing device includes: an on-screen generating section that generates an on-screen signal for displaying an on-screen display superimposed on an image based on an input video signal, and that generates on-screen flags indicating the position of the on-screen display on the image; a combining section obtaining a composite image by combining the on-screen display with the image based on the input video signal; a first scaling section scaling the composite image to conform to a display region, constituted of fixed pixels, on a display section; a second scaling section scaling the on-screen flags in accordance with the scaling processing by the first scaling section; and an image quality adjusting section that adjusts the image quality of the composite image only during the period for which the on-screen flags after having undergone the scaling processing by the second scaling section are inactive, and that does not adjust the image quality of the composite image during the period for which the on-screen flags after having undergone the scaling processing are active.

The above and other objects, features and advantages of the invention will become more clearly understood from the following description referring to the accompanying drawings.

### BRIEF DESCRIPTION OF THE DRAWINGS

FIG. 1 is a block diagram of a conventional television receiver having an on-screen superimposing function;

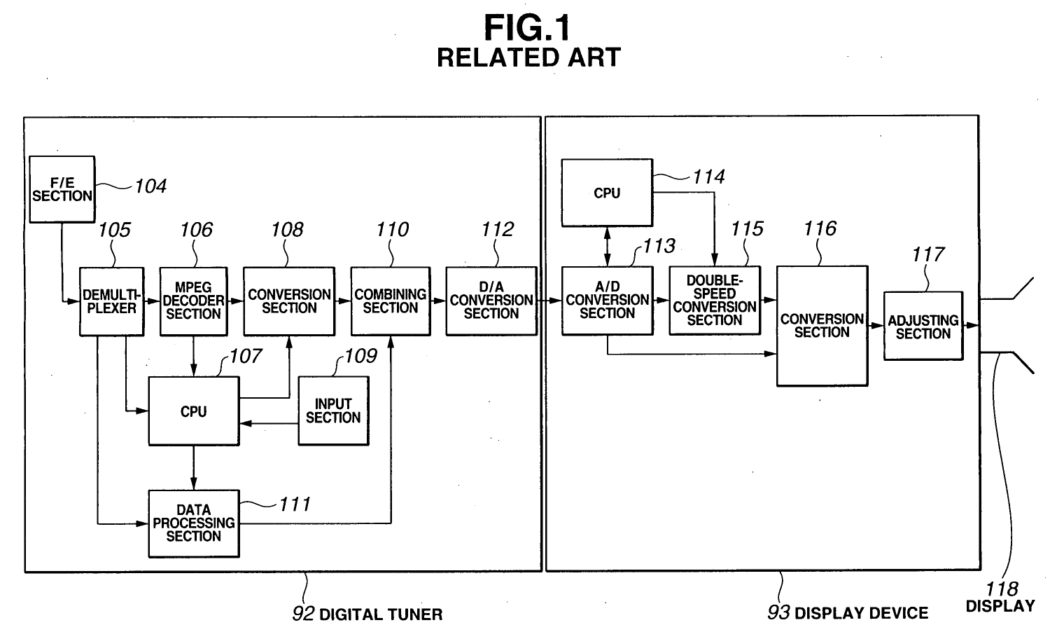

FIG. 2 is a block diagram of a video signal processing device according to a first embodiment of the present invention;

FIG. 3 is a chart explaining operations in the first embodiment;

FIG. 4 is an explanation diagram of the external appearance of the device in the first embodiment;

FIG. 5 is a block diagram of a video signal processing device according to a second embodiment of the present invention;

FIG. 6 is a representation explaining an index-scheme color lookup table;

FIG. 7 is a block diagram of a video signal processing device according to a third embodiment of the present invention;

FIG. 8 is an explanation diagram of the external appearance of the device in the third embodiment;

FIG. 9 is a block diagram of a video signal processing device according to a fourth embodiment of the present invention; and

FIG. 10 is a flowchart showing the flow of video signal processing.

### DESCRIPTION OF THE PREFERRED EMBODIMENTS

Hereinafter, embodiments according to the present invention will be described with reference to the accompanying drawings.

### First Embodiment

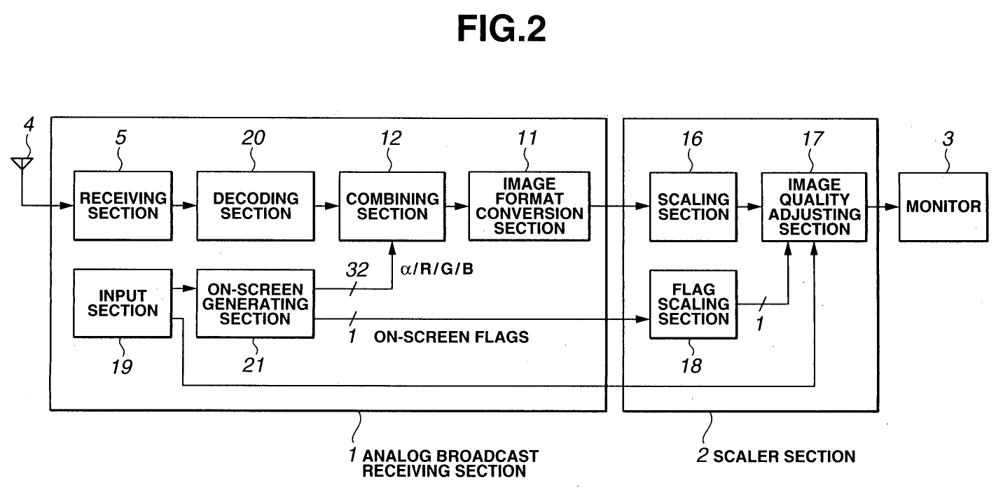

FIG. 2 is a block diagram of a video signal processing device according to a first embodiment of the present invention.

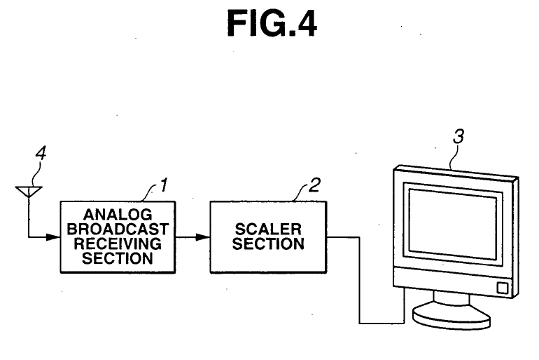

This embodiment is an example that is applied to an analog television receiver. As shown in FIG. 2, the analog television receiver according to this embodiment includes an analog broadcast receiving section 1, scaler section 2, monitor 3, and antenna 4. FIG. 4 shows the external appearance of this device, in which the monitor 3 is not a CRT, but a flat panel constituted of fixed pixels, such as a digital light processing (DLP) display panel, plasma display panel, or the like.

The broadcast signal received through the antenna 4 is supplied to a receiving section 5 of the analog broadcast receiving section 1. The receiving section 5 tunes and demodulates the inputted broadcast signal. The receiving section 5 then outputs a video signal of a base band to a decoding section 20. The decoding section 20 converts the inputted video signal into RGB video signals and outputs them to a combining section 12.

On the other hand, an input section 19 outputs an operation signal based on the user's operation with respect to a remote controller and main body keys (neither of which is shown), to an on-screen generating section 21 and an image quality adjusting section 17 in a scaler section 2. The on-screen generating section 21 outputs an on-screen signal based on the operation signal to the combining section 12.

The on-screen generating section 21 has a character memory (not shown), and reads out therefrom R(red), G(green), and B(blue) signals for performing a display based on an operation signal. Then, the on-screen generating section 21 outputs these R, G, and B signals in synchronization with the RGB video signals from the decoding section 20 so as to cause the R, G, and B signals to be displayed in predetermined positions on an image based on a broadcast signal. In this case, the on-screen generating section 21 outputs also information on a combining ratio α for specifying the superimposition amount of on-screen signals. For example, the on-screen generating section 21 outputs α, R, G, and B signals, which are each a 8-bit signal and 32-bit signals in all).

The combining section 12 combines the R, G, and B video signals from the decoding section 20 and those from the on-screen generating section 21 in accordance with a combining ratio α. Thus, the combining section 12 outputs a composite image in which an on-screen image based on the user's operation has been superimposed on an image based on a broadcast signal at the combining ratio α. This composite image is supplied to an image format conversion section 11.

The image format conversion section 11 converts an interlaced signal from the combining section 12 into a progressive signal to conform to a display system of the monitor 3. For example, if the monitor 3 is a liquid crystal display according to a progressive input, and the reception signal thereof is a broadcast signal according to NTSC (National Television System Committee) system, the image format conversion section 11 converts an interlaced signal (the number of effective lines is 480; hereinafter this signal is referred to as 480i) into a progressive signal (the number of effective lines is 480; hereinafter this signal is referred to as 480p), and outputs it. The composite signal from the image format conversion section 11 is supplied to a scaling section 16 in the scaler section 2.

Also, in this embodiment, the on-screen generating section 21 generates 1-bit on-screen flags indicating the superimposition period of an on-screen signal. The on-screen flags indicate, for every line, during what period of the horizontal periods of a video signal from the decoding section 20 the on-screen signal is to be superimposed by, for example, the time interval between pulses at high level. The on-screen flags from the on-screen generating section 21 are supplied to a flag scaling section 18 in the scaler section 2.

The scaling section 16 constituting the first scaling section performs scaling processing in order to cause the sizes of the length and width of a composite image from the analog broadcast receiving section 1 to conform to those of the display screen of the monitor 3, which is a flat panel constituted of fixed pixels. Scaling methods include a various methods, such as a method in which the horizontal and vertical sizes of the display screen are each linearly changed. When using this method, suppose that the display screen of the monitor 3 is constituted of, e.g., XGA (Extended Graphic Array) pixels (1024×768 pixels). Then, because the composite image of 480p comprises 720×480 pixels, the scaling section 16 magnifies the composite image by about 1.4 times in the horizontality thereof and by 1.6 times in the verticality thereof, by interpolation processing or the like. The composite image having undergone the scaling processing is provided to an image quality adjusting section 17 by the scaling section 16.

In this embodiment, the flag screen section 18 constituting the second scaling section is to scale the on-screen flags, as in the case of the scaling processing in the scaling section 16. The flag screen section 18 generates new on-screen flags in correspondence with scanning lines interpolated by the scaling processing in the vertical direction in the scaling section 16. Also, with respect to the on-screen display portion interpolated by the scaling processing in the horizontal direction in the scaling section 16, the flag screen section 18 correspondingly varies the pulse interval of the on-screen flags. Thereby, the on-screen flags from the flag scaling section 18 indicate the superimposition period of an on-screen signal in the video signal of the composite image after scaling processing. The on-screen flags from the scaling section 18 are outputted to the image quality adjusting section 17.

With respect to the composite image from the scaling section 16, the image quality adjusting section 17 performs image quality adjusting based on the operation signal from the input section 19, and outputs the composite image having undergone the image quality adjusting to the monitor 3. Here, the image quality adjusting section 17 adjusts the image quality by, for example, a predetermined computing processing with respect to the composite image. In this embodiment, when the superimposition period of an on-screen signal is indicated by on-screen flags from the flag scaling section 18 (i.e., when the on-screen flags are active), the image quality adjusting section 17 is adapted not to perform image quality adjusting processing.

The monitor 3 displays the composite image from the scaler section 2 on the display screen.

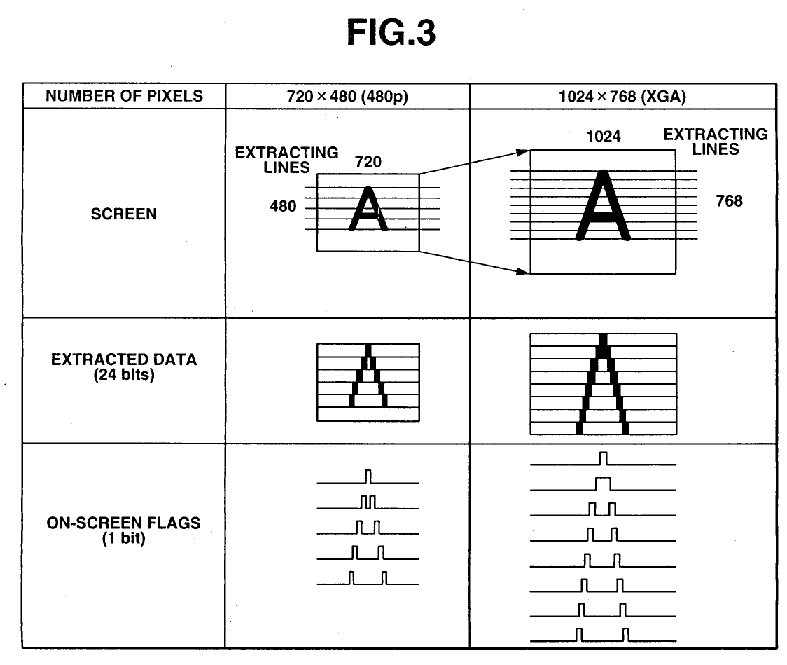

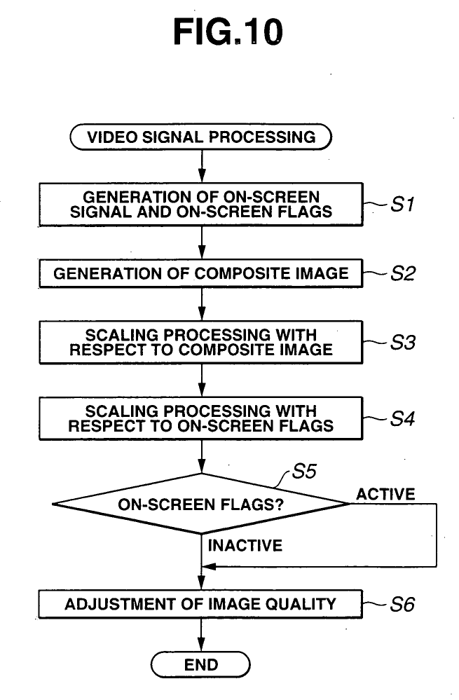

Next, operations in this embodiment having the described features will be explained with reference to a chart in FIG. 3 and a flowchart in FIG. 10. Here, FIG. 3 shows the correspondence between the composite image and the scaling flags before and after scaling processing. FIG. 10 shows a processing procedure of video signal processing.

The antenna 4 is assumed to receive a 480i video signal according to the NTSC system, and the monitor 3 is assumed to be a liquid crystal display based on a progressive input and have a display region with 1024×768 pixels.

The broadcast signal received through the antenna 4 is tuned and demodulated in the receiving section 5, and converted into RGB video signals in the decoding section 20. The video signal from the decoding section 20 is provided to the image format conversion section 11 via the combining section 12. When no on-screen display is performed, the combining section 12 outputs the inputted video signal as it is. This video signal is subjected to interlace/progressive conversion (I/P conversion) in the image format conversion section 11 so as to conform to a display method of the monitor 3 to display the video signal. Namely, the 480i video signal is converted into a 480p video signal.

Here, for example, suppose that the user makes an input operation with a remote controller or main body keys in order to perform a sound volume adjustment or an image quality adjustment or the like. The input section 19 outputs an operation signal based on the user's operation to the on-screen generating section 21. Based on the operation signal, the on-screen generating section 21 generates on-screen signals for causing the display to display on-screen displays such as characters and/or figures for various menu screens and channel displays or the like (step S1 in FIG. 10). For example, the on-screen generating section 21 generates 32-bit on-screen signals that are constituted of RGB signals each being a 8-bit signal, and a 8-bit signal indicating information on a combining ratio α, and then outputs these on-screen signals to the combining section 12.

Also, the on-screen generating section 21 generates 1-bit on-screen flags indicating, for every line, at what timing during the scanning periods of a video signal an on-screen display is to be performed (step S1). The on-screen flags are outputted to the flag scaling section 18 of the scaler section 2.

In step S2, the combining section 12 superimposes an on-screen signal on a video signal at a combining ratio α, and outputs the video signal of the composite image to the image format conversion section 11. In this case, the image format conversion section 11 converts the video signal of the composite image including an on-screen display into a 480p signal and outputs it.

A video signal from the analog broadcast receiving section 1 is supplied to the scaling section 16 of the scaler section 2. In step S3, the scaling section 16 scales the inputted video signal in accordance with the sizes in length and width of the monitor 3. FIG. 3 shows, in a “screen” column thereof, composite images before and after scaling proceeding. The example in FIG. 3 is one in which a 480p composite image constituted of 720×480 pixels is converted into a composite image constituted of 1024×768 pixels, based on the XGA standard. This indicates that the scaling processing increases the number of pixels of the 480p composite image in the horizontal direction by a factor of about 1.4, and increases the number of extracting lines in the vertical direction by a factor of 1.6.

A “extracted data” column in FIG. 3 shows on-screen signals extracted in the respective extraction lines shown in the “screen” column. The number of extraction lines before scaling processing is five. When the number of extraction lines after scaling processing is also set at the same line interval as that before scaling processing, it becomes eight since the number of lines in the vertical direction is magnified by 1.6 times. The on-screen signal comprises 24 bits of R, G, and B signals, each being 8-bit signal. In FIG. 3, the superimposition periods of an on-screen signal in extraction lines are shown painted-out for every extracting line.

On the other hand, the flag scaling section 18 is given on-screen flags by the on-screen generating section 21. As describe above, the on-screen flags indicate the display position of an on-screen display in a composite image before undergoing scaling. The flag scaling section 18 scales the on-screen flags in synchronization with the scaling processing by the scaling section 16 (step S4). An “on-screen flag” column in FIG. 3 shows variations of the on-screen flags in extraction lines between before and after scaling processing.

As shown in the “on-screen flag” column in FIG. 3, the flag scaling section 18 adds corresponding on-screen flags in accordance with the interpolation in the vertical direction. Also, the flag scaling section 18 elongates the high level period (active period) of on-screen flags in correspondence with the pixels of on-screen display increased in number in accordance with the interpolation processing in the horizontal direction. This results in that the on-screen flags after scaling processing indicate, for every line, the superimposition periods of the on-screen display on the composite image after scaling processing.

There is no change in the bit number of on-screen flags between before and after scaling processing. That is, the scaling of flags can be achieved by 1-bit processing, thereby allowing the magnitude of the circuit of the flag scaling section 18 to be small.

Based on an operation signal from the input section 19, the image quality adjusting section 17 performs an image quality adjustment with respect to the video signal of a composite image from the scaling section 16 (step S6). In this case, during the period for which on-screen flags after having undergone scaling by the flag scaling section 18 are active, the image quality adjusting section 17 completes the processing based on step S5 and does not perform an image quality adjustment. Here, the image quality adjustments by the image quality adjusting section 17 include the adjustments with respect to contrast, brightness, depth of a color, hue, image quality (frequency characteristic), and the like.

Thereby, a video signal of the composite image in which only the image except for an on-screen display portion has been undergone an image quality adjustment, is outputted from the image quality adjusting section 17. This video signal is supplied to the monitor 3 and projected on the display screen. Therefore, even when the user performs an operation for image quality adjustment, the on-screen display portion is displayed in a standard image quality without being affected by the image quality adjustment. This provides clear visibility to an on-screen display such as an adjustment value or the like, thereby allowing high operability to be assured.

Thus, in this embodiment, even when scaling the video signal of a composite image on which an on-screen display has been superimposed at a pre-stage of image quality adjustment processing, it is possible to recognize the superimposition period of an on-screen signal in the video signal of a composite image by virtue of the on-screen flags after scaling, by generating on-screen flags indicating the superimposition period of an on-screen display, and scaling the on-screen flags in accordance with the scaling processing with respect to the video signal. Use of the on-screen flags allows the on-screen display to be displayed in a standard image quality without performing an image quality adjustment with respect to the on-screen display portion. This prevents the on-screen display from having reduced visibility due to the image quality adjustment, thereby allowing enhanced operability to be ensured.

The scaling processing may be performed before an image quality adjustment, and the combination between a video signal such as a broadcast signal and an on-screen signal may be performed after an image quality adjustment. In this case, a method can be adopted in which the scaling of a video signal and that of an on-screen signal are performed independently of each other, in which an image quality adjustment is performed with respect to the video signal after scaling, and in which the video signal after the image quality adjustment and the on-screen signal after the scaling are combined. Even in this case, an on-screen display without being affected by the image quality adjustment can be achieved. However, this method requires two scaling circuits of the same kind, thereby increasing the magnitude of circuitry. In contrast, a video signal processing device in a second embodiment shown in FIG. 2 has only to add a circuit for scaling 1-bit on-screen flags, thereby advantageously reducing the increase in the magnitude of circuitry.

### Second Embodiment

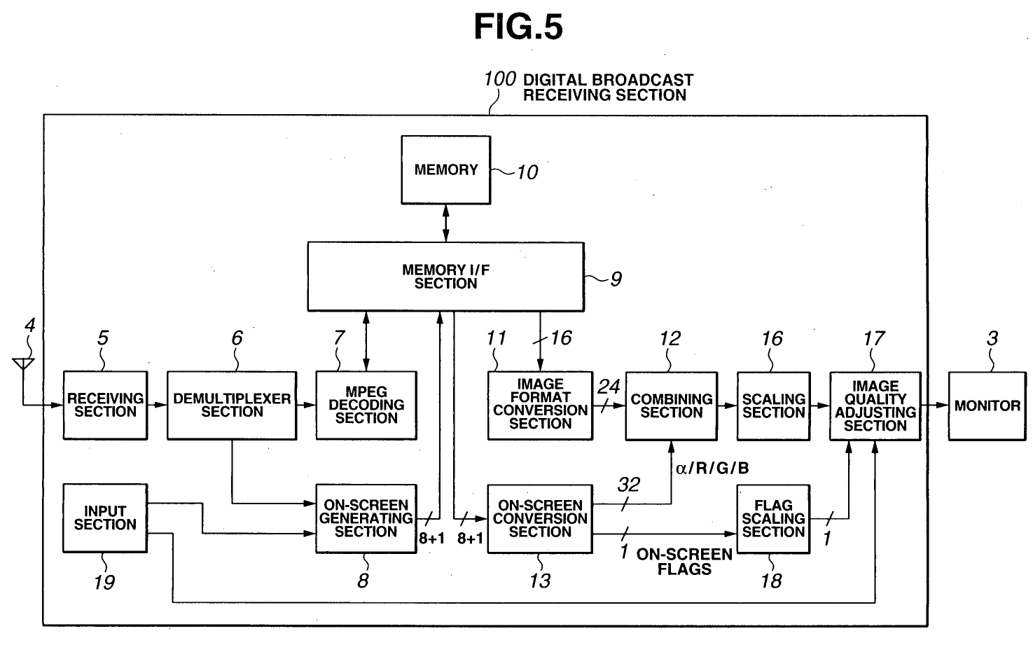

FIG. 5 is a block diagram of a video signal processing device in the second embodiment of the present invention. In FIG. 5, the same components as those in FIG. 2 are designated by the same reference numerals, and the descriptions thereof are omitted.

This embodiment is an example that is applied to a digital television receiver for receiving a digital broadcast. The digital television receiver in this embodiment includes a digital broadcast receiving section 100, monitor 3, and antenna 4.

A demultiplexer section 6 of the digital broadcast receiving section 100 receives a transport stream obtained by the tuning and demodulation by a receiving section 5. The demultiplexer section 6 mutually separates a video signal, audio signal, data broadcast signal, and the like that are multiplexed in the transport stream, then outputs the video signal to an MPEG decoding section 7, and outputs the data broadcast signal to an on-screen generating section 8 serving as an on-screen information generating section. The MPEG decoding section 7 decodes the inputted video signal and thereby obtains a video signal of a base band. The MPEG decoding section 7 is adapted to cause a memory 10 to store the decoded video signal via a memory I/F section 9.

The on-screen generating section 8 provides a function similar to that of the on-screen generating section 21 in FIG. 2, together with an on-screen conversion section 13. The on-screen generating section 8 and the on-screen conversion section 13 generate not only an on-screen signal based on operation signal from the input section 19, but also that based on the data broadcast signal included in the transport stream. In the example in FIG. 5, the on-screen generating section 8 uses “index” scheme in order to save space.

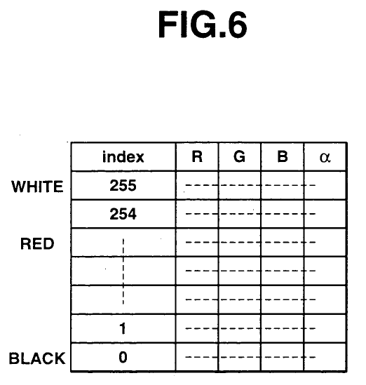

FIG. 6 is a representation explaining the index-scheme color lookup table.

In the index scheme, usable colors are set for every index. FIG. 6 shows a color lookup table of 256 gradations, in which the ratios of R, G, and B components are specified for every index. Also, the combining ratios α between the colors of the indices and the video signals are also set for every index. Therefore, when using the color lookup table in FIG. 6, the on-screen generating section 8 can indicate by an 8-bit index signal that it on-screen displays some of colors of 256 gradations at some combining ratio α. The on-screen generating section 8 causes the memory 10 to store the operation signal from the input section 19 and the index signals based on a data broadcast via the memory I/F section 9.

Simultaneously with the generation of the index signal, the on-screen generating section 8 generates 1-bit on-screen flags indicating the display position of an on-screen display on the data broadcast, and causes the memory 10 to store the 1-bit on-screen flags via the memory I/F section 9.

The on-screen conversion section 13 accesses the memory 10 via the memory I/F section 9, and reads out an index signal. Then, based on the read-out index signal, the on-screen conversion section 13 refers to the lookup table, and obtains an on-screen signal in synchronization with a video signal based on a broadcast signal. The on-screen signal from the on-screen conversion section 13, which corresponds to the on-screen signal from the on-screen generating section in FIG. 2, is provided to the combining section 12. Here, the on-screen conversion section 13 outputs, for example, α, R, G, and B signals, which are each an 8-bit signal and 32-bit signals in all.

The on-screen conversion section 13 outputs the on-screen flags read-out from the memory 10, to the flag scaling section 18. The on-screen flags from the on-screen conversion section 13 indicates the superimposed position of the on-screen signal on the data broadcast.

It is obvious that, as long as it is adaptable to the data broadcast, the on-screen generating section 21 in FIG. 2 can be used instead of the on-screen generating section 8 and the on-screen conversion section 13.

In this embodiment, an image format conversion section 11 is installed at a pre-stage of the combining section 12. The image format for a data broadcast is defined as an interlaced signal (1080i), in which the number of effective lines is 1080. With this being the situation, after having been converted into 1080i, the video signal based on the broadcast signal is to be combined with an on-screen signal. The image format conversion section 11, for example, converts a video signal of 480i into that of 1080i, and further converts it into R, G, and B signals, which are each 8-bit signal and 24-bit signals in all. Then, the image format conversion section 11 outputs these R, G, and B signals to the combining section 12.

The combining section 12 combines the on-screen signal from the on-screen conversion section 13 with the R, G, and B signals from the on-screen conversion section 13 at a combining ratio α, and outputs the video signal of the composite image to the scaling section 16. The scaling section 16 converts the 1080i video signal into a progressive signal (1080p), in which the number of effective lines is 1080, and thereafter scales it in accordance with pixels of the monitor 3.

Other constructions of this embodiment are the same as those in the first embodiment in FIG. 2.

Next, operations of this embodiment with such features will be described.

The broadcast signal received through the antenna 4 is tuned and demodulated in the receiving section 5, and supplied to a demultiplexer section 6, as a transport stream. The demultiplexer section 6 separates a video signal, audio signal, and data broadcast signal from a transport stream, and outputs the video signal to the MPEG decoding section 7, as well as outputs the data broadcast signal to the on-screen generating section 8. The MPEG decoding section 7 decodes the inputted coded video signal based on MPEG standard and obtains a video signal of a base band. This video signal is stored into the memory 10 via the memory I/F section 9.

On the other hand, the on-screen generating section 8 generates an index signal for the on-screen display based on a data broadcast signal and outputs it to the memory 10. When the user's operation, such as a change of sound volume, an image quality adjustment, is performed, an operation signal from the input section 19 is provided to the on-screen generating section 8 based on the user's operation. The on-screen generating section 8 generates an index signal for the on-screen display based on an operation signal and outputs it to the memory 10.

In this embodiment also, simultaneously with the generation of the index signal, the on-screen generating section 8 generates 1-bit on-screen flags indicating the display position of an on-screen display. The on-screen flags are also provided to the memory 10 via the memory I/F section 9. The on-screen flags in this case are signals that become active at the timing corresponding to the display position of the on-screen display, taking the data broadcast screen as reference.

The image format conversion section 11 reads out a video signal from the memory 10, and converts the read-out video signal into 1080i video signal in order to cause the read-out video signal to correspond to the data broadcast screen. Furthermore, the image format conversion section 11 converts the 1080i video signal into R, G, and B video signals and outputs them to the combining section 12. On the other hand, the on-screen conversion section 13 reads out an index signal from the memory 10, and converts it into R, G, and B signals and a combining ratio α for performing an on-screen display. The on-screen signal and the information on the combining ratio α from the on-screen conversion section 13 are provided to the combining section 12. Here, the reading-out of the video signal and that of the index signal from the memory 10 are performed in synchronization with each other, in order to generate a composite image.

The combining section 12 combines the video signal and the on-screen signal that correspond to the data broadcast screen at a combining ratio α, and outputs the R, G, and B signals of the composite image to the scaling section 16. The on-screen conversion section 13 outputs also on-screen flags, which indicate the superimposition period of the on-screen signal on the data broadcast screen, to the flag scaling section 18.

The scaling section 16 scales the composite image in accordance with the screen of the monitor 3. Here, the screen of the monitor 3 is assumed to have a progressive-type display region with 1024×768 pixels. In this case, the scaling section 16 is to perform scaling after having converted the 1080i video signal of the composite image into 1080p video signal. The scaling section 16, therefore, converts the 1080p video signal of 1920×1080 pixels into the progressive video signal of 1024×768 pixels. Hence, the scaling section 16 reduces the composite image of the 1080p video signal by about 0.5 times in the horizontality thereof and by about 0.7 times in the verticality thereof, e.g., by thinning-out processing.

On the other hand, the flag scaling section 18 has been given the on-screen flags read-out from the memory 10 via the on-screen conversion section 13. As described above, these on-screen flags indicate the display position of the on-screen display in the composite image. The flag scaling section 18 scales the on-screen flags in synchronization with the scaling processing by the scaling section 16. In this case, the flag scaling section 18 deletes corresponding on-screen flags in correspondence with the thinning-out processing in the vertical direction. Also, the flag scaling section 18 shortens the active period of on-screen flags in correspondence with the pixels of on-screen display, reduced in number in accordance with the thinning-out processing in the horizontal direction. This results in that the on-screen flags after scaling processing indicate, for every line, the superimposition periods of the on-screen display on the composite image after scaling processing. In this embodiment also, there is no change in the bit number of on-screen flags between before and after scaling processing, thereby allowing the magnitude of the circuitry of the flag scaling section 18 to be small.

Based on an operation signal from the input section 19, the image quality adjustment section 17 performs an image quality adjustment with respect to the video signal of a composite image from the scaling section 19 only during the period for which on-screen flags are active. Thereby, the video signal of the composite image in which only the image except for an on-screen display portion has been undergone an image quality adjustment, is outputted from the image quality adjusting section 17, and projected on the display screen of the monitor 3. Therefore, even when the user performs an operation for an image quality adjustment, the on-screen display portion is displayed in a standard image quality without being affected by the image quality adjustment, thereby allowing high operability to be ensured.

### Third Embodiment

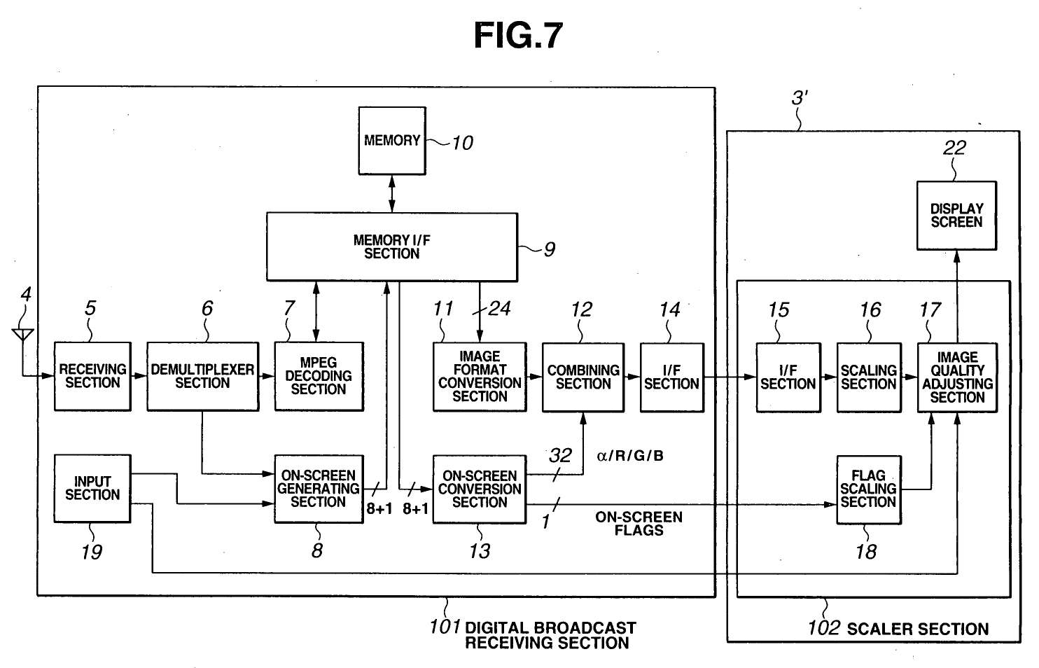

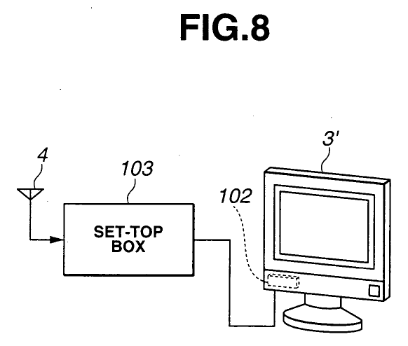

FIG. 7 is a block diagram of a video signal processing device according to a third embodiment of the present invention, and FIG. 8 shows the external appearance of the device in the third embodiment. In FIG. 7, the same components as those in FIG. 5 are designated by the same reference numerals, and the descriptions thereof are omitted.

The present embodiment adopts a digital broadcast receiving section 101 in which a scaler section 102 thereof is formed separately therefrom, instead of the digital broadcast receiving section 100 in the second embodiment. The digital broadcast receiving section 101 is shown as a set-top box 101 in FIG. 8. As shown in FIG. 7, the digital broadcast receiving section 101 is constructed by eliminating the scaling section 16, flag scaling section 18, and image quality adjusting section 17 each shown in FIG. 5, and adding an I/F section 14.

The scaling section 16, flag scaling section 18, and image quality adjusting section 17 in FIG. 5 are incorporated in the scaler section 102 in FIG. 7, and this scaler section 102 is incorporated in a monitor 3′ in this embodiment. The monitor 3′ is equal to the monitor 3 incorporating the scaler section 102. A display screen 22 of the monitor 3′ comprises a display section constituted of fixed pixels, of a liquid crystal panel or the like. Meanwhile, in FIG. 5, the display screen 22 is omitted from illustration. The scaler section 102 in FIG. 7 has an I/F section 15 besides the scaling section 16, flag scaling section 18, and image quality adjusting section 17 in FIG. 5.

The I/F section 14 of the digital broadcast receiving section 101 converts the video signal of an composite image from the combining section 12 into a predetermined transmission format and outputs it. The I/F section 15 of the scaler section 102 can exchange data with the I/F section 14 through a transmission path (not shown). After having the transmission signal format-converted, the I/F section 15 takes out the video signal, and outputs it to the scaling section 16.

Other constructions, operations, and effects of the third embodiment are the same as those of the second embodiment.

Meanwhile, it is obvious that the scaler section 102 may have the monitor 3′ as a separated one instead of incorporating therein.

### Fourth Embodiment

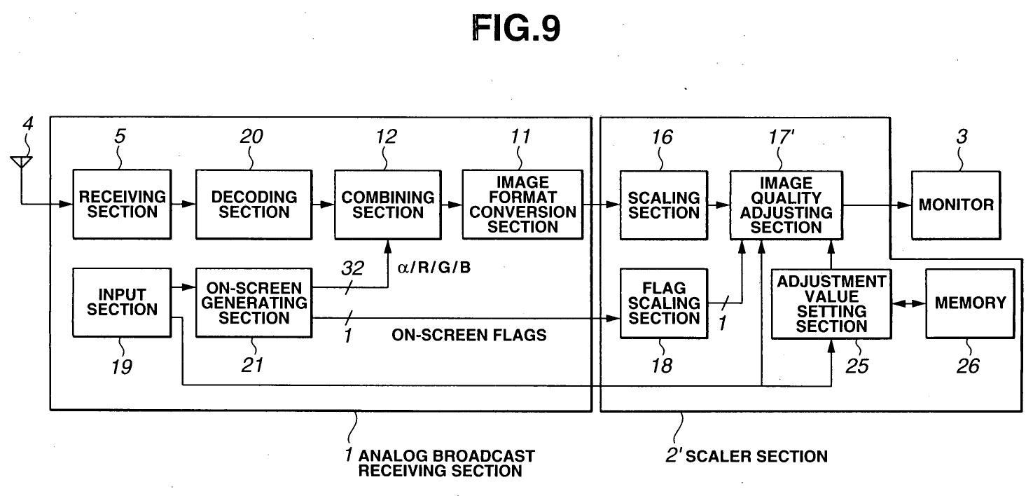

FIG. 9 is a block diagram of a video signal processing device according to a fourth embodiment of the present invention. In FIG. 9, the same components as those in FIG. 2 are designated by the same reference numerals, and the descriptions thereof are omitted.

This embodiment is different from the first embodiment in that a scaler section 2′ having an adjustment value setting section 25 and a memory 26 that are additionally provided, is adopted instead of the scaler section 2 in FIG. 2.

With respect to the on-screen display, this embodiment can perform an image quality adjustment different from that with respect to the image based on a broadcast signal. The memory 26 stores various adjustment values for image quality adjustment with respect the on-screen display. When an image quality adjustment value with respect to the on-screen display is designated by an operation signal based on the user's operation, or when an adjustment value stored in the memory 26 is read out, the adjustment value setting section 25 outputs an adjustment value with respect to the on-screen display to an image quality adjusting section 17′. When the onscreen flags are inactive, the image quality adjusting section 17′ performs an image quality adjustment based on the user's operation with respect to the portion other than the on-screen display, and when the onscreen flags are active, the image quality adjusting section 17′ performs an image quality adjustment based on an output of the adjustment value setting section 25 with respect to the on-screen display portion.

The present embodiment with these features allows an image quality adjustment exclusively for the on-screen display to be performed. Thereby, it is possible to even more enhance the on-screen display to improve the visual recognition by the user and to perform on-screen displays to meet the user's visual recognition.

It is evident that the fourth embodiment is likewise applicable to the second or third embodiment.

As described above, in each of the foregoing embodiments, one-bit on-screen flags are used, thereby allowing the increase in magnitude of circuitry to be reduced. In the present invention, however, on-screen flags of a plurality of bits may be used to improve the accuracy. This prevents errors of scaling from occurring on the boundaries of an on-screen display region. In this case also, as long as the number of bits of on-screen flags is relatively small, the increase in the magnitude of circuitry can be sufficiently restrained as compared with the case where the on-screen signal itself is scaled.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A video signal processing device comprising:
an on-screen generating section that generates an on-screen signal for displaying an on-screen display superimposed on an image based on an input video signal, and that generates on-screen flags indicating the position of the on-screen display on the image;
a combining section obtaining a composite image by combining the on-screen display with the image based on the input video signal;
a first scaling section scaling the composite image to conform to a display region, constituted of fixed pixels, on a display section;
a second scaling section scaling the on-screen flags in accordance with the scaling processing by the first scaling section; and
an image quality adjusting section that adjusts the image quality of the composite image only during the time period for which the on-screen flags after having undergone the scaling processing by the second scaling section are inactive, and that does not adjust the image quality of the composite image during the time period for which the on-screen flags after having undergone the scaling processing are active.

2. The video signal processing device according to claim 1, wherein the on-screen generating section generates an on-screen signal for performing an on-screen display in accordance with an operation input.

3. The video signal processing device according to claim 1, wherein the on-screen flags generated by the on-screen generating section are 1-bit flags that indicate a superimposition period of the on-screen signal in each line.

4. The video signal processing device according to claim 3, wherein the second scaling section makes a deletion or addition of on-screen flags and changes the active period of the on-screen flags, in accordance with deleted or added pixels based on thinning-out or interpolation processing by the first scaling section.

5. The video signal processing device according to claim 1, further comprising, in a pre-stage of the first scaling section, an image format conversion section converting the format of the video signal of the composite image in accordance with the display form of the display section.

6. The video signal processing device according to claim 1, wherein the input video signal is obtained by decoding a digital broadcast signal, and wherein the on-screen generating section generates an on-screen signal for performing an on-screen display based on a data broadcast, included in the digital broadcast signal.

7. The video signal processing device according to claim 1, wherein the on-screen generating section comprising:
an on-screen information generating section that generates on-screen information for displaying an on-screen display superimposed on an image based on an input video signal, and that generates on-screen flags indicating the position of the on-screen display on the image;
a storage section for storing the on-screen information; and
an on-screen conversion section generating an on-screen signal based on the on-screen information from the storage section.

8. The video signal processing device according to claim 1, wherein, during the time period for which the on-screen flags after having undergone scaling processing by the second scaling section are active, the image quality adjusting section adjusts the image quality of the composite image by using an adjustment value for on-screen display.

9. A method for processing a video signal, the method comprising:
generating an on-screen signal for displaying an on-screen display superimposed on an image based on an input video signal, and generating on-screen flags indicating the position of the on-screen display on the image;
obtaining a composite image by combining the on-screen display with the image based on the input video signal;
scaling the composite image to conform to a display region, constituted of fixed pixels, on a display section;
scaling the on-screen flags in accordance with the scaling processing with respect to the composite image; and
performing an adjustment of the image quality of the composite image only during the time period for which the on-screen flags after having undergone the scaling processing are inactive, and performing no adjustment of the image quality of the composite image during the time period for which the on-screen flags after having undergone the scaling processing are active.

10. A video signal processing device comprising:
on-screen generating means that generates an on-screen signal for displaying an on-screen display superimposed on an image based on an input video signal, and that generates on-screen flags indicating the position of the on-screen display on the image;
combining means obtaining a composite image by combining the on-screen display with the image based on the input video signal;
first scaling means scaling the composite image to conform to a display region, constituted of fixed pixels, on a display section;
second scaling means scaling the on-screen flags in accordance with the scaling processing by the first scaling section; and
image quality adjusting means that adjusts the image quality of the composite image only during the time period for which the on-screen flags after having undergone the scaling processing by the second scaling section are inactive, and that does not adjust the image quality of the composite image during the time period for which the on-screen flags after having undergone the scaling processing are active.
